(19) United States
(12) Patent Application Publication
(10) Pub. No.: US 2006/0004921 A1
(43) Pub. Date: Jan. 5, 2006

(54) Systems and methods for establishing communication between users

(76) Inventors: Carol S. Suess, Redmond, WA (US); Hansen Wat, Redwood Shores, CA (US); Loyal Mealer, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/881,043

(22) Filed: Jun. 30, 2004

(51) Int. Cl. G06F 15/16

(52) U.S. Cl. 709/227

(57) ABSTRACT

In one embodiment, there is shown a method for establishing communication between users by providing to a first user the identity of a second user automatically selected from a group of users; and establishing a communication connection from the first user to the identified second user while the identity is being provided to the first user only if the first user desires to establish the communication connection.

### FIELD OF THE INVENTION

The following description relates generally to establishing communications between users and more specifically to systems and methods for creating a chance meeting environment for the selective establishment of communication connections between certain users.

### DESCRIPTION OF RELATED ART

People who work (or live, or shop) in the same physical location often meet, on a chance basis, other people who work (or live, or shop) at that location. These chance meetings, which are often brief, serve to increase common bonds between the participants.

Chance meetings naturally decrease when people are geographically (or otherwise) separated. This decrease in chance meetings has the effect of people “losing touch” with each other. In geographically dispersed peer groups, such as sales or engineering teams, the “out of sight-out of mind” syndrome can negatively impact overall performances of the team. When management is separated from the staff, this same lack of contact can be detrimental. Similarly, in personal situations, friends and relatives who are out of sight are often not thought about as often as one would like.

Chance meetings are not entirely random, but involve complex factors and social behaviors. For example, people do not see each other unless they have enough in common to be in the same place at the same time (e.g., company cafeteria, neighborhood grocery store, airport). Having seen each other, they must also recognize each other despite changes that have taken place since their last meeting. Furthermore, both people must be willing to communicate with each other. Either person, if unwilling to communicate with the other, can choose to duck away from the encounter (leave the immediate vicinity while pretending not to see the other person) or cold-shoulder the other person (pointedly ignore or refuse to acknowledge the other person).

### BRIEF SUMMARY OF THE INVENTION

In one embodiment, there is shown a method for establishing communication between users by providing to a first user the identity of a second user automatically selected from a group of users; and establishing a communication connection from the first user to the identified second user while the identity is being provided to the first user only if the first user desires to establish the communication connection.

In another embodiment, there is shown a telephone system comprising means for identifying to a potential calling party an identity of a selected potential called party said potential called party selected from a group of parties who have indicated willingness to be called by said potential calling party and are currently available for accepting a communication connection; and means for establishing a communication connection to the selected potential called party upon a signaled acceptance by the potential calling party of the identified potential called party.

### BRIEF DESCRIPTION OF THE DRAWINGS

FIG. 1 shows a block diagram of one embodiment of a system for establishing communication connections;

FIGS. 2A-2D show embodiments of tables used to control the establishment of communication connections; and

FIGS. 3A and 3B show one embodiment of a flow chart for controlling the establishment of communication connections.

### DETAILED DESCRIPTION

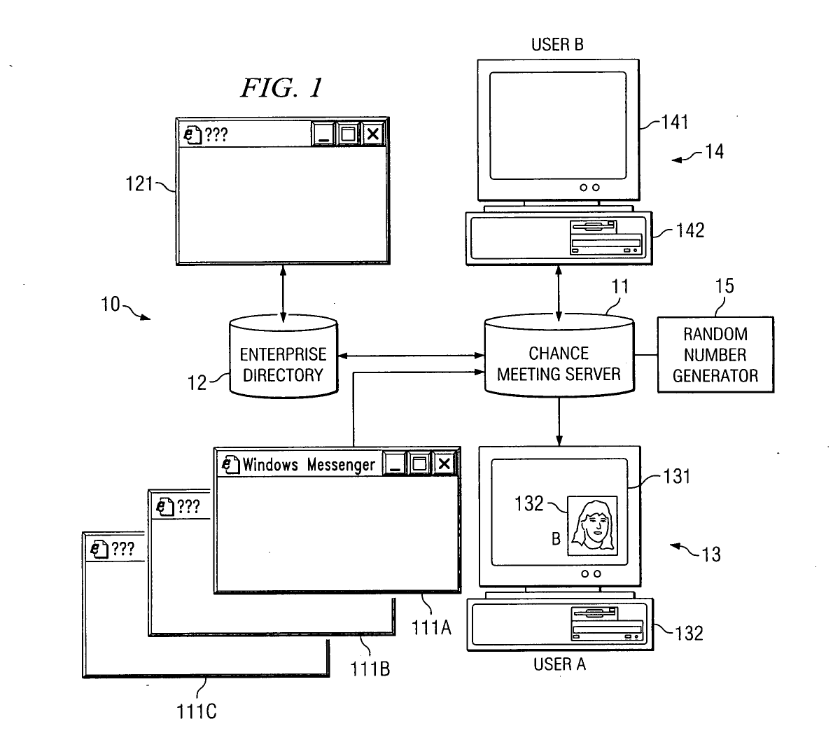

FIG. 1 shows block diagram 10 of one embodiment of a system for establishing communication connections between users. FIG. 1 shows terminal 13 for use by user A and terminal 14 for use by user B. However, it should be understood that the system handles any number of users at any type of terminal, including personal computers (PCs), cell phones, laptops, personal digital assistants (PDAs) wireline phones, etc. It should also be understood that at some points in time user A would be a potentially called user which user B would be a calling user. In the embodiment shown, user A for convenience will be termed the calling user and user B will be termed the potential called user. Note that while the discussion focuses on interactions between and among people, this concept can be used for interdevice communication, as well.

Chance meeting server 11 controls which calling user A will be given the opportunity to call which called user B under the conditions set forth in databases contained either within chance meeting server 11 or extraneous thereto. Contained within chance meeting server 11 would be all of the elements typically within a server, including memory, processors, clocks and other server utilities. These utilities include application software programs for controlling the operation of the system. One or more chance meeting servers 11 can have access to one or more directories, such as enterprise directories 12. Each directory would include data files from a number of sources, and data from these directories may be viewed on server 121, if desired. For example, a directory may be a database of a corporation's or other business's employee information such as their payroll data, email data, etc.). Selected information may also be made available to be searched and viewed by management and/or by other employees. Enterprise directory information may include, for example, employee name; identifying information such as a company-assigned employee number; location/address; contact information such as phone numbers, email addresses, etc.; position within the organization reporting structure; job title; responsibilities; areas of expertise; photograph(s) of employee; or links to other databases, URLs, etc. other directories (affinity categories) could be families, schools, alumni, apartment, residence, associations, etc.

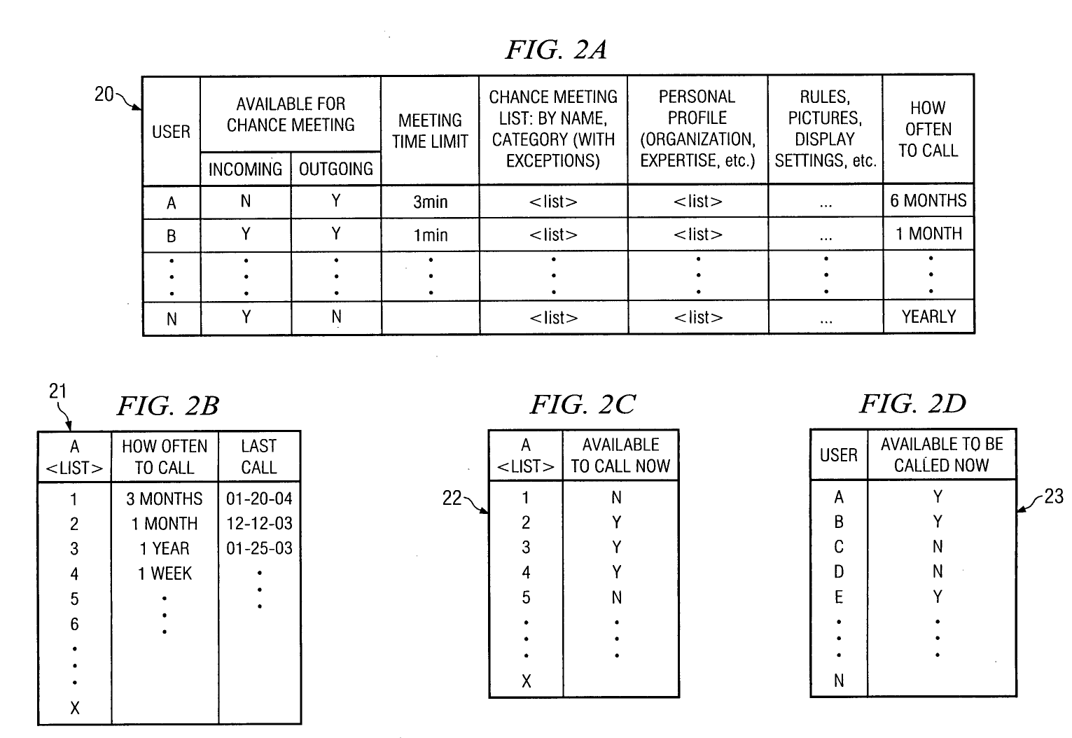

Communicating with chance meeting server 11 are lists 111A, 111B and 111C, which, for example, could include for each user people the user is willing to “meet.” These people may be identified by name with additional identifying information (e.g., John Smith who works at Acme Parts Company in Spokane, Wash., and attended high school with me and whose email address is john.smith@acmeparts.com). People may be identified by category e.g., anyone who worked on a business project with me in the past 10 years; anyone who attended my high school the same years I did and was active in the drama club; anyone in my immediate family including aunts, uncles, siblings, and cousins. Optionally, the lists could include those who are not to be “chance met,” such as NOT anyone who worked with me on “Project boring”; NOT “Bob Jones”; NOT “Aunt Meridith.” Examples of these lists are shown in FIGS. 2A-2D discussed below, and the method discussed with respect to the embodiment shown can be run on server (processor) 11 or on a processor local to a user.

If the implementation optionally includes security measures, security levels or criteria for verifying identity may be set for individuals and/or for categories of people. Known or innovative security measure may be used for purposes which may include but are not limited to: verifying identity, encrypting or otherwise ensuring that communications are secure.

Meeting frequency may be set for each person and/or category, and a history of meeting contacts may be kept for comparison to the meeting frequency settings. Such settings may include, for example, not-to-exceed frequency (e.g., once a year, once a month, etc.). If the not-to-exceed frequency is reached, the individual in question will be temporarily suspended as someone the user is willing to meet and moved to “Avoid” status until enough time has elapsed. Other target frequencies may include, for example, ranges (e.g., at least once a month but not more than once a week); minimum (e.g., at least twice a week); as often as possible; upon occurrence of same event (e.g., during the week of their birthday, anniversary), or a chance meeting with one person may be triggered after a successful chance meeting with another person, such as triggering a meeting with a relative (spouse, brother, etc.) of a person that has been met.

If meeting frequency with some person or category falls below the specified target, the system may assign a higher priority to meetings with that person or category, up to and including seek status. The user may specify what action is to be taken when someone who has been assigned seek status becomes available for a meeting, optionally including: always suggest available seek status individuals for chance meetings if any are available when the user is active in the chance meeting application. The system would notify the user (according to user-set parameters) if a seek status individual becomes available for meeting when the user is not active in the chance meeting application. Optionally, the user may assign seek status to an individual or category in order to make a purposeful search for an available individual or member of that category.

The user may assign various settings, which may be standard and/or determined by the user, to facilitate accurately designating the people the user is willing to meet at any given time. For example, after a long, taxing day at work a user might choose to be available only to favorite long-time friends. Additionally, the factors may be used to influence the order in which the names of available users are suggested to a potential caller (e.g., a user may set the system so that, all else being equal, baseball buddies' names receive priority treatment during baseball season; names may remain on the screen for longer or shorter times depending on how long the user has known the person). Examples of such settings could include: flagging individuals as friend, colleague, relative, golfing buddy, contact, etc. These need not be mutually-exclusive categories. Some settings might be ranges, such as a Like/Dislike range or Long-Time/New Acquaintance range. As discussed above, the system could keep the names of people the user is not willing to meet. This could be kept individually or by categories, in the same way as the people the user is willing to meet.

The system could keep track of personal information, which may include links to personal information kept elsewhere (some or all of which may only be available if the individual or system seeking to access them has qualifying security clearance). For example, “anyone in my immediate family” or “in my department” or “who went to school with me” requires information on the user's immediate family, department, and educational background.

Information may include:
Work-related information, including job, work history, resume, teams and projects the person has worked on, etc. This information may include links to current and/or prior employers' enterprise directories or other databases.

Family information, which may include links to family tree or genealogy applications.
Vitae information, such as schools attended, organization membership, citizenship, places of residence, etc., and the associated dates for each.
If any of the organizations, employers, schools, etc., provide security processes for verifying the users' identity, etc., then optionally there may be provision made to link to or otherwise use those security processes.
Photo(s), video clip(s), audio clip(s).
Information concerning preferred ways to contact other users or to be contacted by the other users (e.g., by e-mail, home telephone, work telephone, cellular telephone, etc.).

Optionally, the user may be able to use a calendar or other scheduling tool to schedule times to be automatically active in the system, either as a potential caller or as a user available to be potentially called. Scheduling may be done on a one-time and/or recurring basis. An individual who is available for chance meetings at a known time each day can use the tool to achieve something much like the “drop-in office hours” which are used in various professions. By coordinating times when they are available, groups can achieve something like a common Coffee Break time. The calendar or other scheduling tool may be part of the chance meeting system, or the system may work in cooperation with other calendar or scheduling tools. The schedule may specify that at certain times the user would be available to meet with one or more specified sub-sets of the user's list of people the user is willing to meet. For example, on holidays the user might be willing to meet only individuals flagged as friends or family. During working hours, the user might choose to automatically limit chance meetings to colleagues and other business associates.

The system may include integration with other user productivity tools (e.g., telephone, voice over IP device, or other voice device; online calendar; instant messaging, real-time conferencing tools) such that the user can set the user's availability and active status to automatically turn off whenever the user is on the telephone, sets instant messaging status to “busy,” is scheduled to be in a meeting, or is actively using conferencing tools, etc. (The user would have the option of overriding the automatic shut-off.)

User settings may include default settings chosen by the user as well as settings the user specifies for the current session. Settings may include, for example,
Duration of the session: how long the user will be active in that session as a potential caller and/or user available to be potentially called.
Target meeting length and/or meeting duration limit, which would be shown to both parties before they decide to meet. Face-to-face chance meetings carry inherent time limits, which are obvious from the start to the parties involved. Most face-to-face chance meetings last from less than one minute to about five minutes, with a few lasting as long as an hour. For example, meetings on an elevator last until one person's destination floor is reached; people walking quickly down a hall in opposite directions may merely greet each other in passing; people meeting each other in line at the company cafeteria may decide to sit down and have lunch together.
How many people the user is willing to be simultaneously visible to as available to be potentially called.
Privacy/Multi-Person-Meetings/Introduction setting. The user may choose what happens when the user enters into a meeting with another user. The user may choose to stop being visible as available when in a chance meeting. Or the user may choose to turn Multi-Person Meetings on, so that if the user is in a chance meeting with one or more other users, they remain “available” to any users to whom both (or all, if there are already more than two in the meeting) of them are available. (Having another user join the meeting may be subject to the agreement of the users already in the meeting.) If this option is chosen, the user may set a limit to the number of people the user is willing to meet with simultaneously. The user may choose to turn Introduction on, so that if the user is in a chance meeting with one or more other users, they remain “available” to other users to whom at least one of those in the chance meeting is available. (Having another user join the meeting may be subject to the agreement of the users already in the meeting.)

In one embodiment of the system the user can control what information about the user is available to those the user is willing to meet with. This could include:
Photos: If a user chooses to make photos available to people the user is willing to meet with, that user may designate one photo to be seen by business contacts and another to be seen by friends and family.
Physical location: The user may at times choose to make the user's physical location available to all or a subset of the people the user is willing to meet. For example, a user who often works at a home office may choose allow colleagues to see when the user is at the company site, since they may then choose to walk over and talk to the user face-to-face. Physical location and/or other information may appear when, for example, a user right-clicks or hovers the mouse over name and/or photo.

The system would keep track of the number of users who are available to be potentially called the user wishes to see simultaneously when the user is active as a potential caller.

In one embodiment the user might have a preference among available user interfaces (e.g., “skins”). In some cases such user interface skins could help supply social cues for the meetings, by relating the online chance meetings to equivalent face-to-face chance meetings. Possibilities could include, for example:
Name list: may be a list of a user-designated maximum number of names, with their meeting time-limits, and (optionally) with their photos. This option might be useful for people using devices such as mobile phones or handheld computing devices.
Moving past: Names and/or photos move across the screen in a user-designated path (e.g., across the top of the screen, down the side of the screen, etc.) as though the individuals were walking past the user's desk. The speed with which they move could reflect how long or brief a meeting they have specified.
Graphical “skins”: on the computer monitor, which may reflect length of the chance meetings the user is seeking. For example, if the user sets a desired meeting length for very brief meetings, the application window on the user's monitor might appear as an elevator moving up and down the side of the monitor, and the people available for meetings might be shown getting on and off the elevator. For slightly longer meetings the window might show people's names and pictures arriving and pausing at a water cooler and then moving on.

Other preferences could be Security settings, if security options are available, and how contact should be made (e.g., through real-time text messaging online, through voice calls, etc.) and whether when the user is not active, the system should continue to monitor the availability of people the user is willing to meet with and notify the user if someone with seek status becomes available.

In operation, chance meeting server 11, as will be discussed in more detail hereinafter, determines that it is time to provide a particular user A with an opportunity to call a specific user B. Note that in this discussion, the terms user A or user B are each symbolic for any one of a number of users also note that a calling user also includes a user sending a data message. The identity of a selected user B is provided to the particular user A. In one embodiment, this identification could be a telephone number or a picture, such as picture 132 on screen 131 of computer 133 of the potential called user B. User A then has several options. One option is to do nothing. If user A selects the “do nothing” option then after a short period of time image 132 (or whatever other identification is provided to user A) is removed. And at sometime later, either the same day or different day depending upon parameters that are set with respect to system user A, user A will be provided another opportunity for establishing a chance telephone or other communication connection to another (or perhaps the same) user B.

User A could, as another option, elect to attempt to establish a “chance” connection to user B by, for example, using a mouse click or a verbal command. Using this option, upon receipt of a left mouse click (or other signal) the system establishes a connection to user B, for example to computer 142. User A could decide that he or she requires additional information pertaining to potential user B and could then click a right mouse button. This additional information could be, for example, the picture, background, sales information numbers, etc. of user B. Thus, if user A was a manager and the chance call is to a sales person, then the additional information could be sales data, or even personal data about birthdays, spouse or children names, etc. Also, the system can establish a limit for chance meetings at, for example, 1 minute, 2 minutes, etc. Thus, when the communication connection is established it would only last for the predefined period of time.

From user B's perspective, when the communication connection arrives from user A, user B could be notified, for example by a message on screen 141, or by ringing of a telephone (not shown) that this is a chance communication so that the user B can act as he or she would to a chance meeting in the company cafeteria. This notification to the called party could be a picture of the calling user and, if desired, statistics associated with the calling party could be provided to the called party. Of course, user B is free to not accept a calling connection.

Note that the communication between caller user A and user B could be a telephone communication or a data connection (such as text message), and could be wireline or wireless.

FIG. 2A shows one embodiment of database 20, which could be part of enterprise directory 12, for handling multiple users. Database 20 shows for each user whether that user will accept a chance meeting either outgoing (calling) or incoming (called). Database 20 can hold many parameters, some of which are shown.

FIG. 2B shows an embodiment 1 of list 21 for user A showing, for example, the plurality of names 1-N that user A wishes to have chance meetings with. For each name there is shown how often the chance call should be attempted. One column shows when the last call was made. The purpose of database 21 is to be sure that calls are not made to a particular party too often. These numbers could be inputted directly by the user or could be, for example, based upon certain associations, such as, all friends could be set for six month intervals, while sales people in the same group could be set for monthly “chance” calls. Parents could be set daily or weekly and great uncles might be set yearly. Each possible called party could be set individually by the user or could be set based upon the category the potential called party falls under. Also note that other parameters could be established such that a user could, for example, turn off chance calling for a particular category either permanently or temporarily. Thus, during certain times of the year a person may not institute (or receive) chance calls.

FIG. 2B shows that the potential called party has input as to whether or not that user wishes to be called on a chance basis. If desired, other parameters could be added, such as time-of-day for outgoing (or incoming) chance calls, number of chance calls per time period, number of chance calls per category. It is anticipated that the potential called party will be in a group who have (1) specified a desire to establish communication with the calling party and who have (2) indicated that they are currently available for such communication.

FIG. 2C shows an embodiment of a database 22 that shows for each potential calling party (1-X) whether that party is eligible to place a chance call. Similarly, FIG. 2D shows one embodiment of database 23 that shows for each potential called party (A-N) whether that party at that time is eligible to receive a chance call. The eligibility for databases 22 and 23 is determined by the rules discussed above and as shown in FIGS. 2A and 2B. When a number of potential chance meeting participants are available for a particular user, random number generator 15 (FIG. 1) can then be used to help select in a random manner (one or more) names to call from the available names with respect to a potential calling party (user A) and a potential called party (B). Note that at any one time multiple chance calls can occur and, if desired, some of these calls can be multi-party calls among affinity groups as discussed above. Also note that databases 21, 22, 23 can be separate or part of a single database.

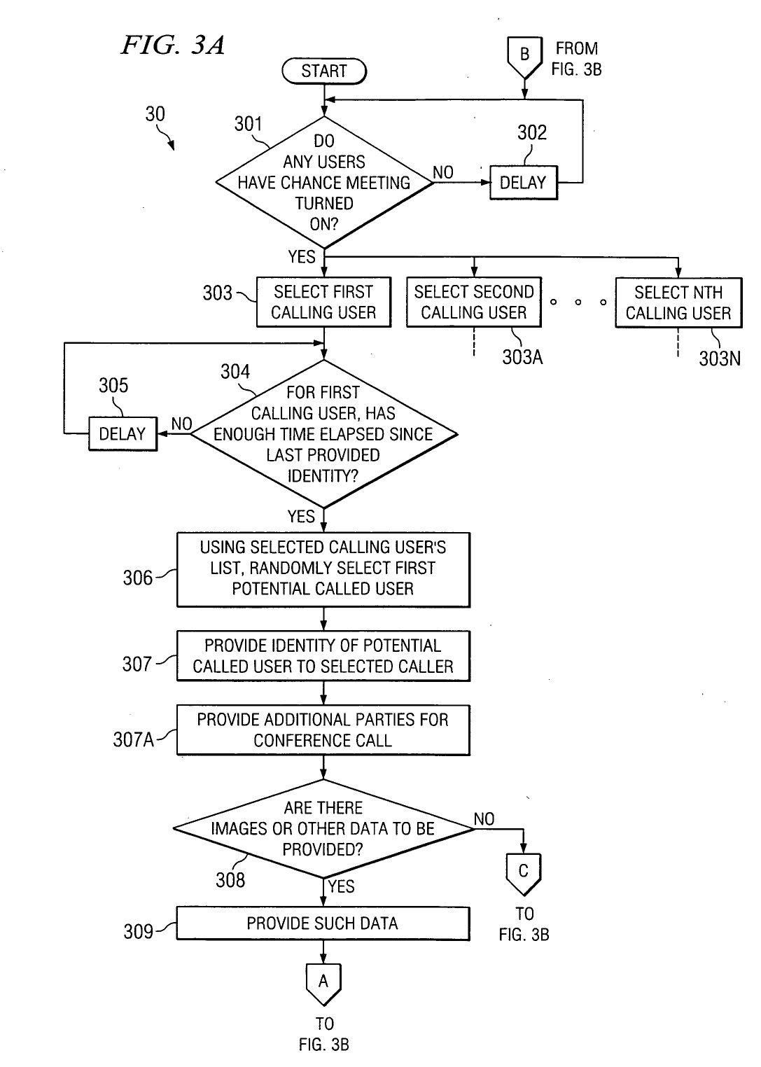

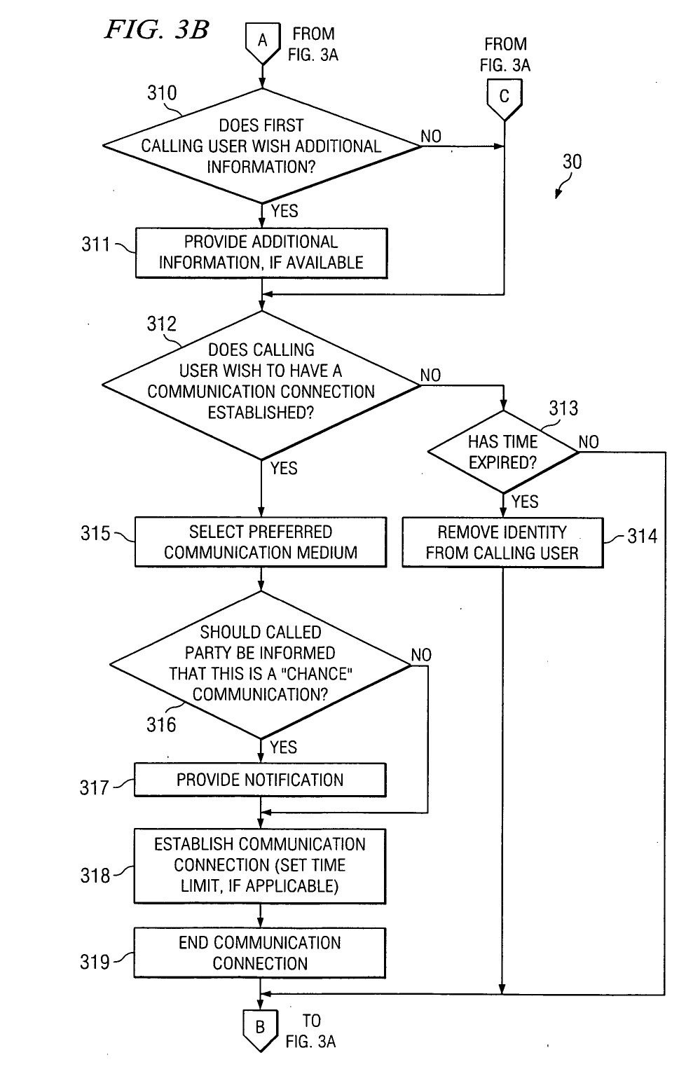

FIG. 3A shows one embodiment of flow chart 30 which controls the call flow discussed above. Process 301 determines whether any users have chance meeting turned on and are currently on the available list. If not then process 302 waits a period of time until on. When any user has chance meeting turned on and is otherwise available process 303 selects a first calling user from among many of the calling users available. This selection can be by random number generator or otherwise. Note that process 303A and 303N do the same thing for other selected users and these other processes 303A to 303N function concurrently with the process described with respect to 303.

Once a calling user has been selected, process 304 determines whether enough time has elapsed since the last chance call. This prevents the calling user from having a constant rush of identities popping up on his or her communication device. The elapsed time can be individual to any particular user or could be standard across all users. If desired, the elapsed time can be modified by each user so that at certain times the user asks the system to provide potential calling parties on a more frequent basis than at other times.

If enough time has not elapsed, delay 305 then delays by enough time and the system goes forward. If enough time has elapsed, then the process 306 selects from the calling users list a random first potential called user. When the identity of the potential called user is identified, process 307 provides that identity to the calling user (user A FIG. 1). This provision can be by number, image, voice, or any other method desired, and can, if desired, vary from user to user. Process 307A controls whether multiple (conference) connections are to be established from time to time. This would be used for family (or other affinity group) telephone “reunions.”

Process 308 determines if other data is to be provided, and if there is then that data is made available via process 309. If the calling user signifies (e.g., with a right click of a mouse button) at process 310 (FIG. 3B) that he or she desires additional information pertaining to the potential called party, process 311 (FIG. 3B) then provides the additional information, if available.

Process 312, FIG. 3B, determines if the selected calling user A wishes to have a communication connection established to the potential called user B. User A can provide indication of whether he/she desires to establish such a connection can be by voice command, mouse click, or any button on a computer, telephone, or other device used by the calling user A. Process 313 determines whether the “decision time” has expired. The decision time in this case is how long the image or other information of the potential called party is to remain identified to the potential calling party for the calling party to decide whether to establish a communication connection with the potential called party. Once the information is no longer provided then the calling party cannot establish the communication other than by the normal method of dialing or emailing the calling party. If the decision time has expired, the identification information is removed by process 314.

If the calling user determines that he or she would like to talk or otherwise communicate with the potential called user, then process 315 selects the preferred communication medium which would be a telecommunication connection either via Internet, local area network (LAN) line, wireless or otherwise. Process 316 determines whether the called party should be informed that this is a chance communication and, if so, process 317 provides the proper notification to the called party. This notification could be a picture or other information pertaining to the calling party. Process 318 establishes the communication connection and, if appropriate, selects a time limit for that call. When the call is completed, process 319 terminates the communication connection. Note that the system could, if desired, provide an option to the parties to continue the call, if they desire. In some embodiments, the length of the meeting, as in “real-world” chance meetings, can be left up to the parties rather than being dictated by the system.

What is claimed is:

1. A method for establishing communication between users, said method comprising:
providing to a first user the identity of a second user automatically selected from a group of users; and
establishing a communication connection from said first user to said identified second user while said identity is being provided to said first user only if said first user desires to establish said communication connection.

2. The method of claim 1 wherein said selected group is predefined by said first user.

3. The method of claim 1 wherein said selected group only contains users who have agreed to accept such random communication.

4. The method of claim 1 wherein said selected group only contains users who are currently available to receive a communication connection.

5. The method of claim 1 wherein said identification includes information selected from the list consisting of images, numbers, names, and addresses.

6. The method of claim 1 wherein said communication connection is dependant upon at least one condition imposed by said second user at a time prior to when the identity of said second user is provided to said first user.

7. The method of claim 1 further comprising:
completing said calling connection under control of said identified second user.

8. The method of claim 7 wherein maximum times are preset for each said completed calling communication connection.

9. The method of claim 8 wherein said preset times are set by each individual user.

10. The method of claim 1 further comprising:
providing an indication to said identified second user that an incoming calling connection is a chance communication.

11. The method of claim 10 wherein said indication comprises a graphic depicting parameters for the calling connection.

12. The method of claim 1 wherein said providing comprises:
providing a plurality of second users concurrently to said first user and wherein said calling connection is established concurrently for said plurality of second users.

13. A system for controlling communication connections between users, said system comprising:
a server for storing identities of users desiring to have chance communications, each said stored identity having associated therewith a set of chance meeting parameters;
a processor for selecting from said server a pair of users having parameters allowing for communication between said user pair;
a display for identifying a potential called user of said user pair to a potential calling user of said pair; and
said processor operable for establishing a calling communication connection between said user pair when said first user signals acceptance of a chance communication while said second user is identified on said display.

14. The system of claim 13 further comprising:
a second processor for completing said calling communication connection to said potential called user under control of said potential called user.

15. The system of claim 13 wherein said identification includes information selected from the list consisting of images, numbers, names, and addresses.

16. The system of claim 13 wherein said processor is further operable for providing additional data to said first user pertaining to said second user when said second user is identified on said display.

17. The system of claim 13 further comprising:
at least one directory of users separate from said server, said stored identities being a subset of users in said directory.

18. The system of claim 17 wherein said users in said directory are at least one affinity group.

19. The system of claim 13 wherein at least some of said stored parameters control which ones of said server stored identities may be presented to any given user.

20. The system of claim 13 wherein at least some of said stored parameters control how often any second user is identified to any particular first user.

21. A communication system, said system comprising:
means for identifying to a potential calling party an identity of a selected potential called party said potential called party selected from a group of parties who have indicated willingness to be called by said potential calling party and are currently available for accepting a communication connection; and
means for establishing a communication connection to said selected potential called party upon a signaled acceptance by said potential calling party of said identified potential called party.

22. The communication system of claim 21 further comprising:
means for controlling any said established communication connection with parameters unique to said calling and called parties.

23. The communication system of claim 21 wherein said selected potential called party is selected from an affinity category of names.

24. The communication system of claim 23 wherein each said category has associated with it a set of rules for determining when a name within said category is eligible for selection.
